(19) United States
(12) Patent Application Publication
(10) Pub. No.: US 2004/0127589 A1
(43) Pub. Date: Jul. 1, 2004

(54) Open-cell microcellular polystyrene foams and method for making the same

(76) Inventors: Mu-Li Chang, Taichung (TW); Pen-Chang Tseng, Hsinchu (TW); Chih-Chen Chang, Hsinchu (TW)

Correspondence Address: BIRCH STEWART KOLASCH & BIRCH, PO BOX 747, FALLS CHURCH, VA, 22040-0747, US

(21) Appl. No.: 10/428,050

(22) Filed: May 2, 2003

(30) Foreign Application Priority Data
Dec. 26, 2002 (TW) 91137445

(51) Int. Cl. C08J 9/00

(52) U.S. Cl. 521/79

(57) ABSTRACT

The invention provides open-cell microcellular polystyrene foams and a method for making the same. The method includes: adding a mixture comprising polystyrene and 8˜14 wt % of additive agent to a double screw extruder for blending; adding the blended mixture with a 2.0˜5.1 wt % of foaming agent to a single screw extruder for blending and foaming to obtain polystyrene foam. Average cell size of the polystyrene foam is equal to or less than 60 μm. Open cell content of the polystyrene foam is equal to or greater than 60%.

### BACKGROUND OF THE INVENTION

1. Field of the Invention

The present invention relates to a method for preparing open-cell microcellular polystyrene foams, and in particular to a method for preparing open-cell microcellular polystyrene foams having tiny cell sizes and high open cell content by double screw and single screw extruders.

2. Description of the Related Art

Extruded closed-cell alkenyl aromatic polymer foam, with cell size between 0.2 and 1.0 mm, has been widely is used as an insulation material. This material exhibits excellent insulation and mechanical strength.

In order to lower the cross-flow thermal conductivity, conventional insulation material made of polystyrene foam must have closed-cell foam structure using foaming gas with low thermal conductivity. By doing so, the foaming gas is restricted in a single cell, thereby reducing the thermal conduction caused by the collision of molecules. However, closed-cell structure is not suitable for a vacuum system, as the gas in the closed-cell foam cannot be vacuumed without destroying its foam structure. Consequently, this feature of closed-cell structure cannot effectively provide good insulation.

### SUMMARY OF THE INVENTION

Accordingly, an object of the invention is to provide a novel formula for making open-cell microcellular polystyrene foam by both double screw and single screw extruders.

Another object of the invention is to provide open-cell microcellular polystyrene foam having tiny cell size and high open cell content.

In order to achieve the above objects, the invention provides a method for making open-cell microcellular polystyrene foam, which includes the steps of: adding a mixture comprising polystyrene and 8˜14 wt % of additive agent (relative to the total weight of polystyrene and additive agent) to a double screw extruder for blending; and adding the blended mixture with a 2.0˜5.1 wt % of foaming agent (relative to the total weight of polystyrene and additive agent) to a single screw extruder for blending and foaming to obtain polystyrene foam; wherein the average cell size of the polystyrene foam is less or equal to 60 μm and open cell content is greater or equal to 60%.

Polystyrene plastic is thermoplastic polymer, which is usually produced by heating polystyrene. When the temperature is greater than the glass transition temperature (T_{g}) polymer becomes plastic. The melt plastic is both viscous and elastic in terms of the rheology properties, and all closely related to temperature, molecular structure, and additive agent added. Preferably the average molecular weight of the polystyrene foam is 220,000-300,000.

The additive agent must be well-dispersed when blended with polystyrene. Double screw extruder is used in this invention to effectively provide the high shear rate and distribution required for uniform blending. Preferably operating temperature is 140˜200° C., and ideally in the range of 150˜180° C.

Various types and amounts of additive agent added also change the rheology properties of the melt plastic. Low viscosity is advantageous for breaking the cells, but inhibition of cells and bursting of foam are also induced. In addition, the additive agent also acts as a nucleation agent, which affects the uniformity and cell size of the foam. It also helps to break the cells. The major object of the invention is to produce polystyrene foam suitable as insulation material in a vacuum. Therefore, volatile substances should be avoided. Preferable additive agents are Mica, Perlite, Calcium carbonate, Titanium dioxide, Talc, Barium sulfate, Smoke, Molecular sieves, Aluminum oxide, silica gel or combinations thereof. Among which, Mica, Perlite, Calcium carbonate and molecular sieves are more preferable. The amount of additive agent added is preferably 8˜14 wt % (based on the total weight of polystyrene and additive agent).

Preferably the foaming agent for this invention must exhibit good nucleation ability. With the aid of a suitable additive agent, the required foam structure is thus obtained. The foaming agent is preferably a mixture of 50 wt % difluoromethane and 50 wt % pentafluoroethane (relative to the total weight of difluoromethane and pentafluoroethane). The amount of the foaming agent is preferably 2.0˜5.1 wt %, more preferably 2.3˜4.0 wt % (both relative to the total weight of polystyrene and additive agent).

A detailed description is given in the following embodiments with reference to the accompanying drawings.

### DETAILED DESCRIPTION OF THE INVENTION

Embodiment 1

Mixtures of polystyrene, additive agent and foaming agent (a mixture of 50 wt % difluoromethane and 50 wt % pentafluoroethane) listed in Table 1 are placed in a double screw extruder for blending. A suitable amount (listed in Table 1) of foaming agent is then added based on the total weight of difluoromethane and pentafluoroethane. The mixture is placed in a single screw extruder for blending such that the plastic mixture foams at 126˜135° C. to obtain polystyrene foam. Cell sizes and open cell content are examined and listed in Table 1.

TABLE 1

| | | Foaming | | Open cell |
|---|---|---|---|---|
| | Additive agent | agent | Cell size | content |
| Group | (wt %) | (wt %) | (μm) | (%) |
| 1 | 8Pe + 3Ca | 3.2 | 53 | 93 |
| 2 | 5Pe + 5Mi | 4.7 | 45 | 94 |
| 3 | 10.5Pe + 3.2Ca | 3.6 | 41 | 85 |
| 4 | 10Pe + 3Ca + 1Mo | 2.4 | 47 | 91 |

Embodiment 2

Mixtures of polystyrene and additive agent (8˜11 wt % Pe+3˜3.2 wt % Ca) are placed in a double screw extruder for blending to form uniform mixtures. The mixtures are then mixed with foaming agent (a mixture of 50 wt % difluoromethane and 50 wt % pentafluoroethane) in a single screw extruder for blending such that the plastic mixtures foam at 128-136° C. to obtain polystyrene foams. Amounts of foaming agent added, listed in Table 2, are based on the total weight of difluoromethane and pentafluoroethane. The polystyrene foams are examined for average cell size and open cell content. The results are shown in Table 2.

TABLE 2

| | Foaming | Average cell size | Open cell |
|---|---|---|---|
| Group | agent (wt %) | (μm) | content (%) |
| 5 | 3.8 | 56 | 93 |
| 6 | 2.6 | 56 | 66 |
| 7 | 4.0 | 57 | 86 |
| 8 | 3.2 | 48 | 88 |
| 9 | 3.6 | 52 | 90 |

Embodiment 3

Mixtures of polystyrene and additive agent (8˜10 wt % P+3˜3.2 wt % Ca) are placed in a double screw extruder for blending to form uniform mixtures. The mixtures are then mixed with foaming agent (a mixture of 50 wt % of difluoromethane and 50 wt % of pentafluoroethane) in a single screw extruder for blending such that the plastic mixtures foam to obtain polystyrene foams. Amounts of foaming agent (based on the total weight of difluoromethane and pentafluoroethane) and the foaming temperature are listed in Table 3. The polystyrene foams are examined for average cell size and open cell content. The results are shown in Table 3.

TABLE 3

| | Foaming | Foaming | | Open cell |
|---|---|---|---|---|
| | agent | temperature | Average cell | content |
| Group | (wt %) | (° C.) | size (μm) | (%) |
| 10 | 4.7 | 126 | 37 | 90 |
| 11 | 2.9 | 132 | 52 | 85 |
| 12 | 2.7 | 134 | 46 | 86 |
| 13 | 3.1 | 130 | 42 | 90 |
| 14 | 3.9 | 129 | 47 | 91 |

Embodiment 4

Mixtures of polystyrene and additive agent (8 wt % P+3 wt % Ca) are placed in a double screw extruder for blending to form uniform mixtures. The mixtures are then mixed with 4.8 wt % (relative to the total weight of difluoromethane and pentafluoroethane) of foaming agent (a mixture of 50 wt % difluoromethane and 50 wt % penafluoroethane) in a single screw extruder for blending such that the plastic mixtures foam at 126°C. to obtain polystyrene foams. Amounts of the foaming agent are listed in Table 4. The polystyrene foams are examined for average cell size and open cell content. The results are shown in Table 4.

Embodiment 5

Mixtures of polystyrene and additive agent (10 wt % P +3 wt % Ca) are placed in a double screw extruder for blending to form uniform mixtures. The mixtures are mixed with 3.0 wt % (relative to the total weight of difluoromethane and pentafluoroethane) of foaming agent (a mixture of 50 wt % difluoromethane and 50 wt % pentafluoroethane) in a single screw extruder for blending such that the plastic mixtures foam at 130° C. to obtain polystyrene foams. Amounts of foaming agent are listed in Table 4. The polystyrene foams are examined for average cell size and open cell content. The results are shown in Table 4.

TABLE 4

| | | | | | Thermal | Thermal |
|---|---|---|---|---|---|---|
| | | | | | conductive | conductive |
| | Foam- | | Average | Open | coefficient | coefficient |
| | ing | | cell | cell | before | after |
| | agent | Foaming | size | content | packaging | packaging |
| Group | (wt %) | temperature (° C.) | (μm) | (%) | (W/mk) | (W/mk) |
| Embodiment 4 | 4.8 | 126 | 45 | 82 | 0.036 | 0.01 |
| Embodiment 5 | 3.0 | 130 | 45 | 89 | 0.030 | 0.008 |

According to the results, the polystyrene foam obtained by the method provided in this invention exhibits cell sizes of equal to or less than 60 μm, and the open cell content is greater or equal to 60%. In addition, when the polystyrene foam is packaged as vacuum sheets, its thermal conductivity coefficient is significantly reduced, to about 0.01 W/mk or even less (0.008 for Embodiment 5). Therefore, the insulation effect in enhanced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

what is claimed is:

1. A method for making open-cell microcellular polystyrene foams, comprising:
adding a mixture comprising polystyrene and 8˜14 wt % of additive agent (relative to the total weight of polystyrene and additive agent) to a double screw extruder for blending; and
adding the blended mixture with a 2.0˜5.1 wt % of foaming agent (relative to the total weight of polystyrene and additive agent) to a single screw extruder for blending and foaming to obtain polystyrene foam;
wherein the average cell size of the polystyrene foam is less or equal to 60 μm and open cell content is greater or equal to 60%.

2. The method as claimed in claim 1, wherein the foaming agent is a mixture of 50 wt % difluoromethane and 50 wt % pentafluoroethane (relative to the total weight of difluoromethane and pentafluoroethane).

3. The method as claimed in claim 1, wherein the operating temperature of the double screw extruder is 140˜200° C.

4. The method as claimed in claim 1, wherein the operating temperature of the double screw extruder is 150˜180° C.

5. The method as claimed in claim 1, wherein the temperature of the foaming agent during foaming in the single screw extruder is 126˜136° C.

6. The method as claimed in claim 1, wherein the amount of the foaming agent is 2.3˜4.0 wt % (relative to the total weight of polystyrene and additive agent).

7. The method as claimed in claim 1, wherein the additive agent is Mica, Perlite, Calcium carbonate, Titanium dioxide, Talc, Barium sulfate, Smoke, Molecular sieves, Aluminum oxide, silica gel or combinations thereof.

8. A polystyrene foam, prepared by the following steps:
adding a mixture comprising polystyrene and 8˜14 wt % of additive agent (relative to the total weight of polystyrene and additive agent) to a double screw extruder for blending; and
adding the blended mixture with a 2.0˜5.1 wt % of foaming agent (relative to the total weight of polystyrene and additive agent) to a single screw extruder for blending and foaming to obtain polystyrene foam;
wherein the average cell size of the polystyrene foam is less or equal to 60 μm and open cell content is greater or equal to 60%.

9. The polystyrene foam as claimed in claim 8, wherein the foaming agent is a mixture of 50 wt % difluoromethane and 50 wt % pentafluoroethane (relative to the total weight of difluoromethane and pentafluoroethane).

10. The polystyrene foam as claimed in claim 8, wherein the operating temperature of the double screw extruder is 140˜200° C.

11. The polystyrene foam as claimed in claim 8, wherein the operating temperature of the double screw extruder is 150˜180° C.

12. The polystyrene foam as claimed in claim 8, wherein the temperature of the foaming agent during foaming in the single screw extruder is 126˜136° C.

13. The polystyrene foam as claimed in claim 8, wherein the amount of the foaming agent is 2.3˜4.0 wt % (relative to the total weight of the polystyrene and additive agent).

14. The polystyrene foam as claimed in claim 8, wherein the additive agent is Mica, Perlite, Calcium carbonate, Titanium dioxide, Talc, Barium sulfate, Smoke, Molecular sieves, Aluminum oxide, silica gel or combinations thereof.
